(19) United States
(12) Patent Application Publication
(10) Pub. No.: US 2019/0355064 A1
(43) Pub. Date: Nov. 21, 2019

(54) SYSTEMS AND METHODS FOR DYNAMIC CONSTRUCTION AND REPORTING OF A SHIELDED ETF CREATION BASKET

(71) Applicant: Terence William Norman, Barling Magna-Essex (GB)

(72) Inventor: Terence William Norman, Barling Magna-Essex (GB)

(21) Appl. No.: 16/524,757

(22) Filed: Jul. 29, 2019

Related U.S. Application Data
(63) Continuation-in-part of application No. 15/446,392, filed on Mar. 1, 2017.
(60) Provisional application No. 62/845,985, filed on May 10, 2019.
(60) Provisional application No. 62/711,928, filed on Jul. 30, 2018.
(60) Provisional application No. 62/302,297, filed on Mar. 2, 2016.

(51) Int. Cl. G06Q 40/06; G06Q 40/04; H04L 29/06

(52) U.S. Cl. CPC G06Q 40/06; H04L 63/0807; G06Q 40/04

(57) ABSTRACT

Systems and methods are provided for the dynamic construction and reporting of a shielded ETF creation basket.

### RELATED APPLICATIONS

This application is a continuation-in-part of U.S. patent application Ser. No. 15/446,392, filed on Mar. 1, 2017, the contents of which are incorporated by reference in its entirety in this application. This application further claims the priority and benefit of U.S. Provisional Application Ser. No. 62/711,928, filed on Jul. 30, 2018 and 62/845,985, filed on May 10, 2019, the contents of which are incorporated by reference in their entireties in this application.

### FIELD OF THE INVENTION

The invention relates generally to exchange traded funds (ETFs) and specifically to improved systems and methods for constructing and disclosing a portfolio of assets held by an ETF, known as a creation basket, while shielding the alpha investment strategy and promoting efficient markets by supporting trading of ETF shares at prices close to the net asset value (NAV).

### BACKGROUND

In the investment industry, exchange traded funds (ETFs) are a widely used marketable security that combine features of a mutual fund, which can be purchased or redeemed at the end of each trading day at its net asset value (NAV) with the intraday trading features of a common stock on an exchange. In contrast to mutual fund shares, retail investors can only purchase and sell ETF shares in market transactions. That is, unlike mutual funds, ETFs do not sell individual shares directly to, or redeem their individual shares directly from, retail investors. Instead, ETF sponsors enter into contractual relationships with one or more financial institutions known as “Authorized Participants.” Authorized Participants typically are large broker-dealers. Only Authorized Participants are permitted to purchase and redeem shares directly from the ETF, and they can do so only in large aggregations or blocks (e.g., 50,000 ETF shares) know as creation units.

To purchase shares from an ETF, an Authorized Participant assembles and deposits a designated basket of securities and cash with the fund in exchange for ETF shares. Once the Authorized Participant receives the ETF shares, the Authorized Participant is free to sell the ETF shares in the secondary market to individual investors, institutions, or market makers in the ETF.

The redemption process is the reverse of the creation process. An Authorized Participant buys a large block of ETF shares on the open market and delivers those shares to the fund. In return, the Authorized Participant receives a pre-defined basket of individual securities, or the cash equivalent.

As other investors purchase and sell ETF shares in market transactions at market prices, an ETF's market price will typically be more or less than the fund's NAV per share. These price variances can be caused by a variety of factors (e.g., the underlying value of the ETF's holdings, demand for ETF shares, etc.). For ETFs, the market price typically does not deviate too far from the NAV because of certain disclosure requirements, which allow Authorized Participants to capitalize on arbitrage opportunities. Essentially, an ETF may publish, every 15 seconds, an up-to-date version of its portfolio, including the clear majority of securities it holds, their weights, and the amount of cash necessary to buy the rest. The ETF also typically publishes an estimated cash value of those holdings, known as an Intraday Indicative Value (IIV), based upon the most recent prices of the securities in its basket. A difference between the market price of an ETF and the ETF's IIV provides an arbitrage opportunity.

Upon identification of arbitrage opportunities, Authorized Participants may come to the ETF with a basket of the underlying securities given in the published holdings, which the fund will exchange for a creation unit. Similarly, the Authorized Participants may also buy up shares in the ETF on the market, then exchange them with the fund in return for the published basket of underlying holdings. As a result, if the market price for the ETF starts to rise too far above the price of its underlying stocks or bonds, the Authorized Participants will buy the underlying holdings, exchange them for shares in the ETF, and sell enough of those shares to drive the price back down to net asset value. Conversely, Authorized Participants may buy up any shares of an ETF trading at a discount so that they can turn in large blocks of shares for the more expensive underlying securities. The Authorized Participant receives all the profits from such arbitrage opportunities, while also driving prices for the ETFs close to the prices for the underlying stocks and bonds.

The lynchpin of arbitrage is that traditional ETFs offer transparency. Market participants have real time visibility into the underlying holdings of the ETF. While such disclosures do not present a problem for ETFs that passively track a securities index like the S&P 500 stock index, and generally invest primarily in the component securities of the index (i.e., passive ETFs), the disclosure rules place ETFs that may have a benchmark index, but whose managers may change sector allocations, market-time trades or deviate from the index as they see fit (i.e., active ETFs) at a significant disadvantage. Indeed, if an actively-traded ETF disclosed its exact holdings frequently enough so that arbitrage could take place, there would be no reason to buy the ETF. Investors would simply let the fund managers at the actively-managed ETF conduct all of the research and then wait for the disclosure of best investment strategies. The investors including predatory investors that conduct front running, could then buy the underlying securities and avoid paying the ETF's management expenses, while also impacting market price of the ETF or the value of the shares in the underlying ETF portfolio.

Many funds are interested in putting their active strategies into an exchange-traded fund (ETF) wrapper, but do not because of potential economic loss of a fund's proprietary alpha generation strategies that would be compromised using a traditional active ETF. Because ETF shares will be listed on a Stock Exchange, prospective investors will have access to information about the ETF product over and above what is normally available about a security of an open-end investment company. Information regarding market price and volume is and will be continually available on a real-time basis throughout the day on brokers' computer screens and other electronic services. The previous day's closing price and trading volume information will be published daily in the financial section of newspapers or publicly-available databases.

Unlike existing actively-managed ETFs in the market, a fund will not disclose on a website on each business day (before commencement of trading in shares on the stock exchange) the identities and quantities of all the portfolio instruments held by the fund that will form the basis for the fund's calculation of NAV at the end of the Business Day. Full portfolio transparency facilitates efficient trading of ETF shares in the secondary market, but can be harmful to an ETF because it could and would largely lead to front-running of portfolio adjustments by predatory traders. As a result, the market price of an ETF share may be close to the NAV of the share, but the NAV itself could easily be adversely affected by predatory trading.

Despite the various problems with fully transparent ETFs, most ETFs are largely successful to date because of transparency. The daily disclosure of a fund's portfolio through the creation basket provides (i) efficient creation and redemption, and riskless arbitrage by Authorized Participants in the primary market, (ii) reduced market maker risk in the secondary market, and consequently (iii) tight pricing between the exchange market price and NAV.

In order to avoid negative affects of arbritrage opportunities on the trading value of an ETF, or lost management proceeds by intuitive inventors, and of predatory trading, many funds developed ETF structures that are fully non-transparent (i.e., no daily portfolio disclosure) to hide the alpha-generating strategy. These structures are complicated and omit transparency desired by the market.

Some funds proposed ETF structures that are fully transparent, i.e., 100% daily portfolio disclosure for all the actively-managed ETFs currently approved by the SEC. These funds issue transparent ETFs that operate without daily publication of their portfolios, but instead disclose monthly with a 15-day lag, and publish creation baskets by the National Securities Clearing Corporation (NSCC) with up to 80% of the portfolio.

Attempts at commercializing non-transparent ETFs have resulted in conflicts, for example, with the U.S. Securities and Exchange Commission (SEC).

In view of the various problems associated with fully non-transparent ETFs and fully-transparent ETFs in the fund industry, there is a present need for ETFs with substantial portfolio transparency that can be efficiently traded, while protecting the alpha-generating portfolio strategies and fund performance, all while allowing ETF shares to trade at prices close to the net asset value (NAV).

The invention provides the solution for this present need with improved methods and systems to operate efficiently-traded, non-traditional ETFs having substantial portfolio transparency, while protecting the alpha-generating portfolio strategies and fund performance. In doing so, the invention supports trading of ETF shares at prices close to the net asset value (NAV), while also providing numerous other benefits as described in this application.

### SUMMARY

Illustrative and alternative embodiments of a computer-based, dynamic-shielded, creation basket identification and reporting platform that (i) may evaluate an ETF's NAV, (ii) identifies the specific holdings of the fund, (iii) discloses the holdings in the fund and the ETF creation basket except the weightings of the holdings in the creation basket, and optionally (iv) actively facilitates primary and secondary arbitrage, are described in detail with reference being made to the figures of this application.

According to an exemplary embodiment of the invention, a method of assembling a dynamic stock specific risk (SSR) portfolio is provided. The method includes the steps of: (a) generating, after market close, a portfolio of assets that lists exactly all the assets held by the new or existing ETF; and (b) dynamically and randomly updating a weight distribution of the assets held in the portfolio of assets generated in step (a) based on a volatility of the portfolio of assets, thereby assembling a dynamic SSR portfolio that may mirror the NAV and includes 100% of the assets held by the new or existing ETF. However, while the assets listed on the dynamic SSR mirror the identity of the underlying assets of the new or existing ETF, the weights of the assets may be different. Indeed, in one embodiment, the underlying weights of assets held by a new or existing ETF may not change day-to-day, however, the weights of the SSR portfolio may appear to change, within a range that has been predetermined and uploaded to a database of the system by a regulatory body or fund manager.

In accordance with the invention, the methods and systems shield weightings of the existing ETF, thereby protecting the alpha-generating investment strategy (e.g., weightings are not available to the public, etc.) other than when existing regulations requires (e.g., once per quarter).

According to another exemplary embodiment of the invention, a computer network is provided. The computer network includes: (a) a fund manager computer including information related to a new or existing ETF portfolio; and (b) a service provider computer for receiving the information from the fund manager computer. The fund manager and/or the service provider computer accesses (e.g., local access at the service provider computer, or remotely from another computer) computer program instructions configured to execute a method of assembling a dynamic stock specific risk (SSR) portfolio. In a further embodiment, the fund manager may execute the computer program, which may then execute a method of assembling an SSR portfolio. The method includes the steps of (i) generating a portfolio of assets that are related to assets included in a new or existing ETF, and (ii) dynamically updating a weight distribution of assets included in the portfolio of assets generated in step (i) based on a volatility of the portfolio of assets, thereby assembling a dynamic SSR portfolio, where the names of the assets are published, but the weightings of the assets in the ETF are shielded.

In an exemplary, non-limiting embodiment, the system of the invention comprises a software application. The application can operate on a mobile computer device or on a computer device. The device is in communication through a wired and/or wireless communication network with a fund server located at the ETF's principal executive office or a remote fund server in communication with the fund server through the wired and/or wireless communication network. The software application is configured to receive a fund identification and to communicate the same to the fund server and/or remote fund server.

The system uses a processor that is in communication through the wired and/or wireless communication network with the software application, as well as the fund server and/or remote fund server, and/or the service provider server and/or remote server. Upon communication of the fund identity, a list of all fund holdings with corresponding weights, uploaded by a fund manager, employee or agent of the fund or service provider will be accessed. The processor is configured to determine the shielded creation basket or SSR portfolio by compiling a list of all fund holdings replacing any reference to the actual weight with those that have from 90% up to 100% weighting overlap with the assets in the underlying fund. Finally, the processor is configured to communicate the IIV and/or shielded creation basket to the fund or service provider via the wired or wireless communication network.

In another exemplary, non-limiting embodiment, the system of the invention comprises a software application. The software application can operate on a mobile computer device or on a computer device. The device is in communication through a wired and/or wireless communication network with: (1) at least one exchange server located at a market or exchange where the issuing and trading of equities or stocks of publicly held companies, bonds, or any other classes of securities take place; or a remote exchange server in communication with the exchange server through the wired and/or wireless communication network, and (2) a fund server located at the ETF's principal executive office or a remote fund server in communication with the fund server through the wired and/or wireless communication network. The software application is configured to receive a fund identification and communicate the same to the fund server and/or remote fund server.

The system uses a processor that is in communication through the wired and/or wireless communication network with the software application, as well as the fund server and/or remote fund server, and the exchange server and/or remote exchange server. The processer is configured to call up from a database of the system, upon communication of the fund identification customer order to the fund server: (1) a list of all fund holdings with corresponding weights, which has been previously uploaded by a fund manager, employee or agent of the fund, (2) the current number of outstanding fund shares, which has been previously uploaded by a fund manager, employee or agent of the fund, (3) a price for each identified fund holding, which is publicly available, and (4) a list of third parties who are to receive copies of the shielded creation basket and IIV. The processor is configured to determine the current IIV of the fund by multiplying the fund holdings by their present price and dividing that amount by the current number of outstanding shares. The processor is further configured to determine the shielded creation basket by compiling a list of all fund holdings without any reference to the weight in which such holdings are held. Finally, the processor is configured to communicate the IIV and shielded creation basket to the identified third parties via the wired or wireless communication network.

In another exemplary embodiment, the system comprises a software application operating on a computer device. The software application is configured to request and receive through a wired and/or wireless communication network from a fund server in communication with a database, wherein the fund server is located at a fund location or communicates through the wired and/or wireless communication network with a remote server at a location other than the fund location: (1) the IIV, and/or (2) the shielded creation basket. The system also includes a processor in communication through the wired and/or wireless communication network with the software application, as well as the fund server and/or the remote server. The processer is configured to call up for a database of the system upon request: (1) a list of actual holdings of the fund and corresponding actual weights of each holding, previously uploaded by a fund manager, employee or agent of the fund, (2) a price for each fund holding, (3) a current number of outstanding fund shares, which has been previously uploaded by the fund manager, employee or agent of the fund, (4) a list of third parties to whom the shielded creation basket and/or IIV are to be disclosed previously uploaded by the fund manager, employee or agent of the fund, and (5) at least one guardrail previously uploaded by the fund manager, employee or agent of the fund. Upon receipt of this information, the processor is configured to: (1) determine the actual fund value by multiplying the actual holdings of the fund by each holdings present price, (2) determine the IIV by dividing the actual fund value by the current number of outstanding shares, (3) identify at least one shielded weight for each fund holding, which does not violate the at least one guardrail, (4) compile the shielded creation basket by selecting one shielded weight for each fund holding, and (5) communicate the IIV and/or the shielded creation basket to the software application. Upon receipt of the IIV and/or the shielded creation basket, the software application is configured to communicate the IIV and/or the shielded creation basket to the third parties.

In other embodiments, the selection of the one shielded weight for each fund holding is random.

In certain embodiments one guardrail is an acceptable amount of potential deviation in the weightings of the fund holdings in the shielded creation basket for the ETF from the actual weights of each holding. For example, the acceptable amount of potential deviation may be plus or minus five percent. Furthermore, the system may include two or more guardrails.

In other embodiments, the sum of the shielded weight for each fund holding equals one. Furthermore, the shielded creation basket may be dynamically determined at predetermined intervals. Such intervals may be in a range from 0.1 seconds to 60 seconds.

In other embodiments, the software application communicates the IIV and/or the shielded creation basket to the fund manager, employee or agent of the fund and for approval of the IIV and/or the shielded creation basket prior to communicating the IIV and/or the shielded creation basket to third parties, or websites.

In other embodiments, the system for constructing and reporting a shielded creation basket and/or an IIV comprise a website accessible through a wired or wireless communications network by a unique computer device assigned a unique registered fund credential or by a computer device that is synced to a software application operating on the unique mobile computer device, whereby the unique mobile computer device is assigned the unique registered fund credential. Furthermore, the following may be linked to the unique registered fund credential: (1) a list of actual holdings of the fund and corresponding actual weights of each holding, (2) a current number of outstanding fund shares, and (3) at least one guardrail. Furthermore, the processor may be configured to communicate the IIV and/or the shielded creation basket to the website.

In other embodiments, a method for constructing and reporting a shielded creation basket and an intraday indicative value (IIV) for a fund is disclosed. The method comprises receiving a request for a creation basket and the IIV from a fund server or a remote server placed using a software application operating on a computer device, and wherein the computer device communicates through a wired and/or wireless communication network with the fund server at a fund location or with the remote server in a location that is remote to the fund location and in communication with the fund server. Upon receiving the request for the creation basket and the IIV, the method uses a processor to randomly call up from a database in communication with the fund server: (1) a list of actual holdings of the fund and corresponding actual weights of each holding, (2) a price for each fund holding, (3) a current number of outstanding fund shares, (4) a list of third parties to whom the shielded creation basket and IIV are to be disclosed, and (5) at least one guardrail. With this information, the method uses a processor to: (1) determine the actual fund value by multiplying the actual holdings of the fund by each holdings present price, (2) determine the IIV by dividing the actual fund value by the current number of outstanding shares, (3) identify at least one shielded weight for each fund holding, which does not violate the at least one guardrail, and (4) compile the shielded creation basket by selecting one shielded weight for each fund holding. Finally, the method transmits the IIV and shielded creation basket to a software application or website.

These and other features, aspects and advantages of the present invention will become better understood with reference to the following description and appended claims.

### BRIEF DESCRIPTION OF THE DRAWINGS

Additional aspects, features, and advantages of the invention, as to its system, structure components, configuration, and operability will be understood and become clearer when the invention is considered in view of the following description of the figures made in conjunction with the accompanying drawings, wherein:

FIG. 1 is a block diagram of a suite of software modules in accordance with an exemplary embodiment of the invention.

FIG. 2 is a flow diagram illustrating a method of assembling a portfolio of assets (e.g., a dynamic stock specific risk portfolio) in accordance with an exemplary embodiment of the invention.

FIG. 3 is a flow diagram illustrating the way information may flow over a computer network in accordance with an exemplary embodiment of the invention.

FIG. 4 is a flow diagram illustrating the flow of information of an exemplary embodiment of the invention.

FIG. 5 shows a flow chart of an embodiment of the system.

### DETAILED DESCRIPTION

Various embodiments of the invention are described in detail below with reference to the figures of this application. Although specific implementations are described, this is provided for illustration purposes only. A person skilled in the relevant art will recognize that other components and configurations may be used without parting from the spirit and scope of this disclosure.

Generally, the invention provides methods and systems for creating an ETF, after market close, by a custodian using the system or methods of the invention to generate a creation basket. The creation basket holds only all the underlying portfolio holdings, but not their exact weightings in the creation basket. The system and methods will then randomly generate from 90 up to 100% overlap between the weights of the creation basket and the weights of the holdings of the underlying portfolio. The creation basket will contain 100% of the assets of the underlying portfolio holdings, however, the weights of such holdings in the creation basket may differ from the underlying portfolio holdings. Indeed, the system may maintain a minimum 90% overlap with the underlying asset holdings of the fund. The system and method can use statistical metrics to minimize potential tracking error, and/or non-statistical metrics from the fund's prospectus and statement of additional information (SAD. For example, the ETF provides attributes much more relevant and useful for market trading such as: (1) structural stability and providing an accurate representation of the underlying NAV within high volatility environments; (2) the attributes of the dynamic SSR portfolio may reflect those that are known to the market from the SAI; (3) deliverables as the in-kind basket; and (4) acceptability purposes, that is, a combination of (1), (2), and (3). These “non-statistical” attributes tend to result in an improved reliability of performance, particularly during severe market stress conditions.

This approach establishes a mismatch between portfolio weightings and creation basket weightings that completely obscures the alpha-generating strategy of an ETF. The creation basket is then published by the NSCC for use at next day's open by all market participants for hedging, arbitrage, and creations, like current transparent ETFs.

A unique aspect and benefit of the invention is that it generates a creation basket with full transparency concerning the ETF's portfolio without showing the alpha-generating strategy. The invention shields (i) portfolio alpha results from the manager's dynamic trading strategy, (ii) future target weightings and reasons, (iii) timing of future purchases and selling, and (iv) duration that the position is held. In other words, none of this critical information is published, nor can it be extrapolated or derived from the published information about the ETF, but the market price of the fund tracks the fund's NAV within a typical tolerance.

The benefit of shielding the alpha strategy provides a mechanism to protect against reverse engineering of the IIV or the NAV. No third party, even a blind trust, under a nondisclosure agreement, knows the weightings in the creation basket portfolio. A trader has no knowledge of, and cannot determine, the daily percentage overlap of assets between the underlying fund and the creation basket, nor the daily percentage. And, even if a portfolio could be derived by some means, a trader could not create a metric to determine if it represents the actual portfolio or the creation basket portfolio. For active fund managers, the alpha-generating strategy is protected, while reaping the cost and tax benefits inherent to an ETF wrapper.

The invention promotes mirroring portfolio risks with the creation basket stocks because they are one and the same. Investment constraints in the actual portfolio are mirrored in the creation basket. This results in consistently high correlations and low basis point risk even in volatile market stress conditions.

The invention establishes creation baskets that are not non-transparent ETFs because the holdings of the creation baskets are published, but the specific weightings of the holdings in the creation basket are not published. Indeed, there is no use of proxy stocks in the creation basket to support transparency, nor to generate the IIV or NAV. Furthermore, the invention establishes creation baskets that do not use custom baskets, i.e., stocks in a basket but not in underlying portfolio, or pricing baskets, which may negatively impact the like-kind exchange tax benefits of the ETF wrapper.

Market makers and authorized participants benefit from the invention because the creation basket transparency of the invention reduces trading risk and keeps pricing tight (i.e., between market price vs. NAV). Authorized participants can also create and redeem directly with the fund. The invention establishes creation baskets that inherently have an effective and consistent, bona fide arbitrage mechanism.

Investors benefit from the invention with access to a new investment category and managers with proven track records with ETFs.

Custodians and distributors benefit from the invention because the system cleanly interfaces with current ETF infrastructure without the need for extra systems or technology changes.

In other words, the invention provides a solution for the present need with systems, methods and devices for the dynamic construction and reporting of a shielded ETF creation basket. The invention solves the prior art problems using a computer-based platform that is specially programmed to construct creation baskets for public disclosure that exactly mirror an ETF's holdings without disclosing the weights of such holdings, thus, shielding the fund's alpha-generating strategy.

In one embodiment, the system compiles a shielded creation basket that lists all the fund's holdings, but not their weights to create a shielded creation basket. Finally, the system transmits the shielded creation basket and possibly IIV to a third party.

This dynamic constructing and reporting of a shielded creation basket provides significant benefits for both the fund and the fund's shareholders. The shielded creation basket mitigates the potential risk that the fund's active trading strategy may be replicated or subject to front running, all of which benefits the fund's shareholders and promotes efficient markets.

According to an embodiment of the invention, a fund or a custodian can use the system to construct creation baskets algorithmically after the close of trading and calculation of the NAV. The system can receive several statistical and non-statistical inputs that include: (1) actual portfolio information (only known by a fund or custodian), and (2) information (non-statistical) from a fund's prospectus and SAI. The system then randomly assigns an asset weighting overlap from 90 to 100% and then optimizes the minimum tracking error percentage. The system processes this within minutes to construct an in-kind creation basket. The creation basket is then published through NSCC showing all the stocks in the portfolio, but not their weights, with a minimum 90% overlap with actual portfolio weights for market participants and the public.

The role of the shielded creation basket during the trading day is to calculate IIV, hedge risk, and create and redeem shares. During this process, the weightings mismatch shields the alpha-generating strategy. This is repeated at the close of the markets for the next trading day.

A unique aspect of the invention is its use of a single creation basket for efficiency. There are three reasons for this. First, a single creation basket is more efficient for pricing because it generates the IIV on a 15 second basis on an exchange at high frequency for authorized participants and market makers. Second, a single creation basket is more efficient for creation basket construction by allowing authorized participants to create and redeem and conduct bona fide arbitrage. Finally, a single creation basket promotes risk mitigation because the portfolio authorized participants and market makers can use a single basket to auto-hedge risk of being long or short in the ETF. In summary, the single basket ensures efficient markets.

The new structure provides (1) one creation basket for intraday pricing, hedging, arbitrage and creation/redemption, and (2) that creation basket holds all the names of the portfolio, but not their exact weightings to hide the fund's alpha generating strategy. Every day at the open, the stock weightings in the creation basket will differ from actual portfolio weightings. Day to day, the creation basket weightings will always change, even if no trading occurs in the actual portfolio. In other words, the market will know the stocks held by the fund, but it will not know (1) actual weightings in the creation basket, and (2) the ever-changing percentage weightings in the daily published creation basket will completely shield the actual buying and selling in the fund portfolio.

A detailed discussion of the methods and systems of the invention is provided below. First, a system overview is discussed. Next, the way a user may interact with the system is described. Third, the system components are identified. Fourth, a description of a cloud computing system, the preferred environment of this system, follows. Fifth, exemplary custom shielded creation baskets are disclosed.

System Overview

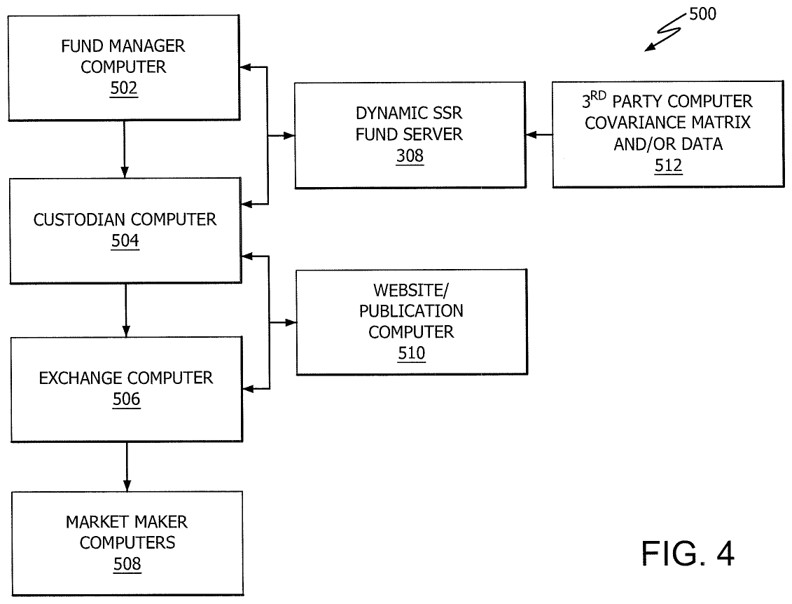

FIG. 4 discloses the system that includes a fund server comprising a processor aided by memory that communicates with the service provider server or directly with the software. Software operates with a database(s) that contains any one or more of: (1) a list of all fund holdings with corresponding weights, which has been previously uploaded by a service provider, fund manager, employee or agent of the fund, (2) the current number of outstanding fund shares, which has been previously uploaded by a service provider, fund manager, employee or agent of the fund, (3) a price for each identified fund holding, (4) a list of third parties who are to receive copies of the shielded creation basket and possibly IIV, (5) previous day time series used to calculate individual stock and equal weighted sector covariance matrices for a universe of stocks, and (6) criteria for creation of a portfolio of assets, which has been previously uploaded by a service provider, fund manager, employee, or agent of the fund. Other than the covariance or reference data information, which is obtained from a third party by the processor, such information may be uploaded to the database by an employee, contractor, or agent of the fund or service provider. The processor is configured to determine the shielded creation basket. Finally, the processor is configured to communicate the IIV and shielded creation basket to the identified third parties via the wired or wireless communication network.

System Interaction with Users

Although the disclosed system can proceed automatically, individual(s) and/or team(s) may interact with users. For example, in one embodiment, a user may audit or change the system's fund selections. This section describes a non-limiting, exemplary embodiments of such interactions in which a professional can review, approve, or change any aspect of the fund. FIG. 6 depicts one embodiment of the high-level capabilities of the system.

User Login

In one embodiment, the system provides for multi-role support. For example, the user may be a fund manager, service provider, employee, or fund agent.

The first step of the software application is for the user to login 600. The user begins by visiting a website or loading a computer application 602. A server determines if this is the first visit by the user 604. If the server determines that this is a subsequent visit, then prior general information (e.g., name, contact information, fund affiliation, etc.) is loaded 606. If this is the first visit by the user, then the same general information is collected 608. Once the user is identified, the user is permitted to sign into the application 610. Upon signing in, the user arrives at the landing page 612. In one non-limiting embodiment, the landing page is dynamic and may display different information depending on the role of the user (i.e., a fund manager would be presented with the different landing page than an employee, who would themselves see a different page from an agent).

Fund Selection

In one embodiment, the ability to review or change the fund selected 614. Such a selection can be aided by a search function that may permit the user to search for funds by the fund's: name, unit size, constraints, or guardrails. Once the fund is selected 614, the user can review the fund's holdings 616, and the user can review and define: the fund's daily portfolio holdings, any exemptions to which the fund is subject, compare the fund's portfolio holdings to prior dates, review any missing portfolio holdings, or add or subtract from the fund holdings depending on the role of the user. A user's role can impose additional review restrictions on their interactions with the system. For example, if the user signs in as a fund employee, then the system can restrict the user to only viewing a list of fund holdings, but not the weights in which they are held. Conversely, a fund manager can be permitted to not only view the weight of all holdings, but also update the holdings. Furthermore, certain users may be permitted to amend holdings for only certain funds.

Amendment of Daily Portfolio Holdings

Once the desired fund has been identified 614 or reviewed 616, the system can coordinate the assembly of its daily portfolio holdings 618. Such amendments can take the form of direct input of daily portfolio holdings by the individual. Conversely, the system can automatically populate the daily portfolio holdings based on information received from the fund manager or service provider. In one embodiment, the system can permit the individual to compare the current daily portfolio holdings to prior daily portfolio holdings. Indeed, the individual can also review missing portfolio holdings.

Generation of Shielded Creation Basket

Once the daily portfolio holdings have been identified 618, the system can remove references to the weights of such holdings, thereby creating a shielded creation basket 620. The system can then display a list of the fund's constraints so that the individual can then review the shielded creation basket to confirm it does not violate any of the constraints. Finally, the individual can authorize the distribution of the shielded creation basket. Once completed, the system can close the session.

The protection mechanism of the invention is illustrated by the following non-limiting example. In effect, the system establishes an overlap in “asset value” between the underlying holdings of the portfolio and the published creation basket. While the creation basket contains all (and only) the stocks that are in the actual portfolio, the percentage weightings of the stocks in the creation basket are randomly generated by algorithms to differ from the fund holdings. This four-stock example depicted in Table 1 below shows a 90% overlap in shielded weightings between the actual portfolio and the creation basket.

TABLE 1

| Weighting % | Stock A | Stock B | Stock C | Stock D | Total |
|---|---|---|---|---|---|
| Actual Portfolio | 35% | 25% | 5% | 35% | 100% |
| Creation Basket Stocks | 28% | 30% | 2% | 40% | 100% |
| Weighting Overlap % | 28% | 25% | 2% | 35% | 90% |

The protection mechanism of the invention is further illustrated by the following non-limiting example in Table 2 below. This example shows a minimum 90% overlap in asset value between the 4 stocks in the underlying holdings of the portfolio and the creation baskets published on day T, day T+1, and day T+2.

TABLE 2

| Weighting % | Stock A | Stock B | Stock C | Stock D | Total | Overlap |
|---|---|---|---|---|---|---|
| Actual Portfolio | 25% | 25% | 25% | 25% | 100% | |

Published Basket On:

| | | | | | | |
|---|---|---|---|---|---|---|
| Day T | 35% | 20% | 20% | 25% | 100% | 90% |
| Day T + 1 | 20% | 20% | 30% | 30% | 100% | 90% |
| Day T + 2 | 15% | 30% | 30% | 25% | 100% | 90% |

The protection mechanism prevents predatory trading or front running as further illustrated in the following non-limiting example depicted in Table 3 below wherein no trading occurs between the close on Day T and the open on Day T+3. The only difference is the baskets published daily by the NSCC. Here, a predatory trader monitoring the creation basket (published with the names of the holdings, but not the weightings) on Day T can believe that the actual fund is substantially composed of Stock A. By Day T+1, the creation basket suggests the actual fund is now selling Stock A and buying Stock C, but, in fact, Stocks A and C remain flat. On Day T+2, the fund appears to be continuing to sell Stock A, but the fund is, in fact, still holding the same assets it held on Day T.

TABLE 3

| | Actual Fund | | | |
|---|---|---|---|---|
| | (unknown to | | | |
| | the market) | Baskets Published Daily by NSCC | | |
| | At the Close | At the Open on | At the Open on | At the Open on |
| | on Day T | Day T + 1 | Day T + 2 | Day T + 3 |
| Stock A | 40% | 48% | 42% | 30% |
| Stock B | 15% | 10% | 10% | 20% |
| Stock C | 45% | 42% | 48% | 50% |
| Total | 100% | 100% | 100% | 100% |

In a non-limiting exemplary embodiment, the overlap can be anywhere from 90 to 100% of the fund holdings' weights. Indeed, the overlap can be 90, 91, 92, 93, 94, 95, 96, 97, 98, 99, or 100% of the fund holdings, or increments less than whole numbers from 90 to 100%.

Guardrails on Weighting Deviations of Securities

Swings in an ETF's holdings can have unintended consequences. For example, the disclosure of a ten percent (10%) reduction in a large ETF's published holdings can have an impact—either positive or negative—on the value of that specific security even though the ETF's actual holdings of the security has not in fact changed.

To mitigate against such unintended consequences, in certain non-limiting embodiments, a portfolio manager, a regulator, or an employee or agent of the portfolio manager or regulator can designate an acceptable amount of potential deviation in the weightings of securities in the published shielded creation basket for an ETF from the weightings of those specific securities in the underlying portfolio. Such maximum deviations may, but are not required to be, publicly-disclosed. Such “guardrails” can help ensure that no individual security in the published holdings for an ETF will be overweighted or underweighted by more than the guardrail percentage when compared to the actual weighting of each security held within the underlying portfolio.

The guardrails can be set for individual stocks in an ETF in at least one of three ways—generally to each security held in an ETF (“general guardrail”), specifically to asset class(es) held in an ETF (“asset type guardrail”), and specifically to one or more securities held in an ETF (“individual specified security”). In an embodiment, if more than one of the guardrail types is set, then the order of precedence of control posed by the guardrails can be set, for example, as: (1) general>individual specified security, or (2) general>asset type>individual specified security. Under the order of precedence of No. (1), and individual specified security guardrail could not override a general guardrail. Under the alternative order of precedence of No. (2), an individual specified security guardrail could not override a general or asset type guardrail; an asset type guardrail could override an individual specified security guardrail but could not override a general guardrail; and finally, a general guardrail could override both an asset type guardrail and an individual specified security guardrail.

A general guardrail can be set that places a maximum amount of deviation (plus or minus) on each security held in an ETF relative to the underlying portfolio weight. In other words, no single deviation of any security held in an ETF can be more than a fixed percentage away from the underlying portfolio weight. For example, assuming (i) a general guardrail was set at 2% for an ETF, and (ii) the underlying portfolio weight of Stock A was 3%, then the position of Stock A within the ETF's creation basket could be set at or between a maximum position of 5% and a minimum position of 1%. The primary purpose of a general guardrail is to prevent stock concentration by enforcing diversification of individual stock risk.

In non-limiting, exemplary embodiments, general guardrail amounts can be set at or between about 0.1% and less than 10%, between about 0.5% and about 5%, or between about 1% and about 2.5%. The guardrails can be set in increments in less than whole numbers. For example, the guardrails can be set at 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, or 9.5%. In alternative embodiments, the general guardrail can be set based on the total number of securities held in the ETF. By way of non-limiting examples, the general guardrail can be 5% if the ETF holds 10 or less securities, 2% if the ETF holds between 11 and 50 securities, 1.5% if the ETF holds between 51 and 100 securities, and 1% if the ETF holds more than 100 securities.

Asset type guardrail(s) can be set in a manner that places a maximum amount of deviation (plus or minus) on specific types of securities held in an ETF. Asset type guardrails provide a fund manager with the ability to better manage investment risk and set risk tolerances based on asset type of the securities held in the ETF. For example, asset type guardrails could be set for (i) equity funds based on any one or more of a security's market capitalization, country of origin (foreign or domestic), American Depository Receipts (ADRs), sector, or industry, (ii) fixed income funds based on credit rating, term, issuer, liquidity, volatility, and/or country of origin (foreign or domestic), or (iii) commodities. For example, an asset type guardrail of 2.5% could be set for all small cap securities held in an ETF. One or more asset type guardrails can be set for an ETF.

Individual specified security guardrails can be set to place a maximum amount of deviation (plus or minus) on specific securities held in an ETF, whereby such deviation must be within the general guardrail. Individual specified security guardrails can be set on an individual basis by a manager on all, some or one security held in the ETF. For example, an individual specified security guardrail for IBM Corp. Holdings could be set at 1% if held in an ETF. This type of guardrail provides a fund manager with the ability to better manage investment risk, set risk tolerance, and fine tune the specific monetary value of one or more holdings in the ETF. The individual specified security guardrails can be set in whole or less than whole numbers within the general guardrail.

Multiple different types of guardrails can be used. For example, a portfolio manager, a regulator, or an employee or agent of the portfolio manager or regulator could designate for an ETF a 5% general guardrail, with a 2% guardrail for all bonds, and a 1% guardrail for IBM Corp. Holdings. Equally, an employee or agent of the portfolio manager or regulator can designate for an ETF at 5% general guardrail, with a 7% guardrail for all bonds, and a 1% guardrail for IBM Corp. Holdings.

In another non-limiting embodiment, the guardrails can be set for entire asset classes in an ETF (“class guardrail”). A class guardrail can be set that places a maximum amount of deviation (plus or minus) on the aggregate asset class holdings of the ETF. Because the class guardrail places limitations on the aggregate class holdings of the ETF and not individual stocks, class guardrails may be set above the general guardrail, however, the general guardrail remains the dominant constraint for individual security weights. For example, an ETF may hold 3 securities A, B and C, which are all small cap stocks with their weights being 5%, 4% and 2% respectively. The general guardrail may be set at 1% while the class guardrail for small cap stocks is set at 1.5% (i.e. the class guardrail is greater than the general guardrail). The interplay between the general guardrail and the class guardrail results in two limitations on the relevant holdings. First, pursuant to the general guardrail, which is the dominant constraint, each stock A, B and C must lie between 4-6%, 3-5% and 1-3% respectively in the basket. Second, pursuant to the class guardrail, the sum of the weights of A, B and C within the basket must lie between 9.5%-12.5%. As a result, baskets can be constructed that have A=4.5%, B=5% and C=2.5% because these meet the general guardrail and they do not violate the class guardrail because their sum is 12% which is a class type deviation of just 1%. However, the guardrails would not permit the basket to have A=6.5% B=4% and C=2% because although the class guardrail is met the general guardrail is violated.

For clarity, in the various embodiments of guardrails, there can only be one general guardrail, the number of “Asset Type” or “Asset Class” guardrails can be equal to or less than the number of “Asset Types” that the manager defines, and the maximum number of individual guardrails is restricted to 2 times the number of securities within the portfolio, i.e., the manager can put an asymmetric guardrail on individual securities.

System Components

A non-limiting embodiment of the system includes a general-purpose computing device, including a processing unit (CPU or processor), and a system bus that couples various system components including the system memory such as read only memory (ROM) and random-access memory (RAM) to the processor. The system can include a storage device connected to the processor by the system bus. The system can include interfaces connected to the processor by the system bus. The system can include a cache of high-speed memory connected directly with, near to, or integrated as part of the processor. The system can copy data from the memory and/or a storage device to the cache for quick access by the processor. In this way, the cache provides a performance boost that avoids processor delays while waiting for data. These and other modules stored in the memory, storage device or cache can control or be configured to control the processor to perform various actions. Other system memory can be available for use as well. The memory can include multiple different types of memory with different performance characteristics.

Computer Processor

The invention can operate on a computing device with more than one processor or on a group or cluster of computing devices networked together to provide greater processing capability. The processor can include any general-purpose processor and a hardware module or software module, stored in an external or internal storage device, configured to control the processor, as well as a special-purpose processor where software instructions are incorporated into the actual processor design. The processor may essentially be a completely self-contained computing system, containing multiple cores or processors, a bus, memory controller, cache, etc. A multi-core processor may be symmetric or asymmetric.

For clarity purposes, an illustrative embodiment of the system is presented as including individual functional blocks having functional blocks labeled as a “processor”. The functions such blocks represent can be provided using either shared or dedicated hardware, including, but not limited to, hardware capable of executing software and hardware, such as a processor, that is purpose-built to operate as an equivalent to software executing on a general-purpose processor. For example, the functions of one or more processors may be provided by a single shared processor or multiple processors. Use of the term “processor” should not be construed to refer exclusively to hardware capable of executing software. Illustrative embodiments can include microprocessor and/or digital signal processor (DSP) hardware, read-only memory (ROM) for storing software performing the operations discussed below, and random-access memory (RAM) for storing results. Very large-scale integration (VLSI) hardware embodiments, as well as custom VLSI circuitry in combination with a general-purpose DSP circuit, can also be provided.

System Bus

The system bus can be any of several types of bus structures including a memory bus or memory controller, a peripheral bus, and a local bus using any of a variety of bus architectures. A basic input/output (BIOS) stored in ROM or the like, can provide the basic routine that helps to transfer information between elements within the computing device, such as during start-up.

Storage Device

The computing device can further include a storage device such as a hard disk drive, a magnetic disk drive, an optical disk drive, a solid-state drive, a tape drive or the like. Like the system memory, a storage device can be used to store data files, such as location information, menus, software, wired and wireless connection information (e.g., information that may enable the mobile device to establish a wired or wireless connection, such as a USB, Bluetooth or wireless network connection), and any other suitable data. Specifically, the storage device and/or the system memory can store code and/or data for carrying out the disclosed techniques among other data.

In one aspect, a hardware module that performs a specific function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld computing device, a desktop computer, or a computer server.

Although an embodiment described herein can employ cloud computing and cloud storage, it should be appreciated by those skilled in the art that other types of computer readable media which can store data that are accessible by a computer, such as magnetic cassettes, flash memory cards, digital versatile disks, cartridges, random access memories (RAMS), read only memory (ROM), a cable or wireless signal containing a bit stream and the like, can also be used in the operating environment. Furthermore, non-transitory computer-readable storage media as used herein can include all computer-readable media, with the sole exception being a transitory propagating signal per se.

Interface

To enable user interaction with the computing device, an input device represents any number of input mechanisms, such as a microphone for speech, a web camera for video, a touch-sensitive screen for gesture or graphical input, keyboard, mouse, motion input, speech and so forth. An output device can also be one or more of several output mechanisms known to those of skill in the art such as a display screen, speaker, alarm, and so forth. In some instances, multimodal systems can be used enable a user to provide multiple types of input to communicate with the computing device. The communications interface generally governs and manages the user input and system output. Furthermore, one interface, such as a touch screen, can act as an input, output and/or communication interface.

There is no restriction on operating on any specific hardware arrangement, and, therefore, the basic features here can easily be substituted for improved hardware or firmware arrangements as they are developed.

Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit, and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform specific functions according to the programming of the module. For example, if a storage device contains modules configured to control the processor, then these modules can be loaded into RAM or memory at runtime or can be stored as would be known in the art in other computer-readable memory locations. Having disclosed some components of a computing system, the disclosure now turns to a description of a cloud-based system, which is a preferred environment of the invention.

Cloud System

Cloud computing is a type of Internet-based computing in which a variety of resources are hosted and/or controlled by an entity and made available by the entity to authorized users via the Internet. A cloud computing system can be configured, wherein a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network enabled computing devices. For example, cloud computing resources can communicate with a server, a database, and/or any other network enabled computing device to provide the cloud resources.

In some cases, the cloud resources can be redundant. For example, if cloud computing resources are configured to provide data backup services, then multiple copies of the data can be stored such that the data is still available to the user even if a storage resource is offline, busy, or otherwise unavailable to process a request. In another example, if a cloud computing resource is configured to provide software, then the software can be available from different cloud servers so that the software can be served from any of the different cloud servers. Algorithms can be applied such that the closest server or the server with the lowest current load is selected to process a given request.

User Terminal

A user interacts with cloud-computing resources through user terminals or testing devices connected to a network by direct and/or indirect communication. Cloud computing resources can support connections from a variety of different electronic devices, such as servers; desktop computers; mobile computers; handheld communications devices (e.g., mobile phones, smart phones, tablets); set top boxes; network-enabled hard drives; and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. However, in other cases, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

Service Models

Cloud computing resources can provide cloud resources to user terminals through a variety of service models, such as Software as a Service (SaaS), Platforms as a service (PaaS), Infrastructure as a Service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

User Interaction

In some cases, cloud computing resources can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or database.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

Exemplary Shield Creation Baskets

In accordance with certain aspects of the invention, a dynamic SSR portfolio is constructed that reliably and contemporaneously calculate an IIV for an actively-managed ETF (also, referred to as an ETF portfolio) where the portfolio manager desires that the alpha-generating strategy (for the existing exchange traded portfolio) is shielded from public view, which may be referred to as a “Shielded Alpha ETF”.

To overcome certain deficiencies of the prior art, inventive techniques for constructing a Dynamic SSR Portfolio for ETF pricing is described. Such a Dynamic SSR Portfolio, represents an algorithmic solution to facilitate structuring and trading of an actively managed ETF (the existing exchange traded fund) that shields a fund's alpha generating strategy. In accordance with aspects of the invention, at no point does anyone other than the fund manager have access to the actual portfolio weightings for the Shielded Alpha ETF. This information remains completely confidential from all market participants.

In accordance with the invention, trading of a Shielded Alpha ETF can be accomplished close to its unknown NAV. Aspects of the invention mimic operation and trading of transparent ETFs in terms of IIV dissemination, hedging risk and in-kind creation/redemption. Such a solution closely resembles operational procedures for current ETFs, accelerating market and regulatory receptivity. The major difference, as previously discussed, for this new class of ETFs is reduced underlying portfolio disclosure. Rather, algorithms and calculations obscure the portfolio (and weightings). In a further embodiment the algorithms and calculations obscure only the portfolio weightings.

### The Pricing Model—the Dynamic SSR Portfolio

In an embodiment of the invention, a Dynamic SSR Portfolio can be constructed and is used to determine an IIV that accurately and contemporaneously approximates the unknown portfolio's NAV (unknown until market close when the true NAV is publicly posted). Construction of the Dynamic SSR Portfolio utilizes a historical time series of share price returns from the previous trading day for every stock within a pre-determined universe of stocks (e.g., mid-point pricing). The universe of stocks used by the fund manager for portfolio selection can be determined, for example, by reference to the SAI and/or the fund prospectus. For example, if the fund is U.S. Large Cap, then the universe would include all of stocks on U.S. exchanges that are classified as “Large Cap”. In a further embodiment the universe of stocks can be restricted to only those stocks contained within the ETF portfolio. The previous day time series can be supplied by an exchange or contracted pricing agent and used to calculate individual stock and equal weighted sector covariance matrices for the universe of stocks. The time series is based upon the latest day prices as the Dynamic SSR Portfolio is calculated, for example, assuming T+1 fund accounting. In a further embodiment, more historic stock pricing data can be used.

The software utilized to generate and store the individual stock and equal weighted sector covariance matrices can reside within the fund manager/sub-advisor's internal computer system, and/or with a third party (e.g., the fund custodian, service provider, a contracted pricing agent, an exchange, etc.). In certain embodiments of the invention, the service provider or custodian can be considered as an ideal party for hosting the software—such that if the custodian is not the party calculating the covariance matrices, the party performing the calculating can then transmit this data to the custodian. In a further embodiment, the party calculating the covariance matrices can be a more suitable party for hosting the software.

Then, software/algorithms (e.g., located on the service provider or custodian's internal computer systems) can undertake analytics to generate a dynamic portfolio of stocks with an identified stock specific risk level (i.e., the Dynamic SSR Portfolio). This is the portfolio that tracks the actual underlying fund portfolio (i.e., the assets held are the exact same, but the weights held can be different—so both in theory and in practice it is highly transparent) but masks the actual weightings of the existing exchange traded portfolio. In a further embodiment, only the actual weightings can be masked. Typically, the number of equities in the Dynamic SSR Portfolio will equal that of the actual underlying portfolio. The term “dynamic” is used since this portfolio can change its percentage weighting composition during the trading day based upon exogenous events. Additionally, disclosed key conditions, constraints and inequalities (e.g., the portfolio is always fully invested) from the SAI are incorporated. It is envisioned that calculation of the Dynamic SSR Portfolio used on day T+1 would take place shortly after the close of trading on day t when the historical time series for day T's trading is available.

Upon the start of next day's trading, the Dynamic SSR Portfolio will be populated with real time share midpoint pricing to determine a contemporaneous price percentage change that is used to generate an IIV that is an accurate representation of the NAV of the underlying portfolio (the existing exchange traded portfolio). In a further embodiment, the Dynamic SSR portfolio could be populated with each stock's last traded prices. Based on current ETF practice, this can be, for example, on a fifteen second basis. Of course, this can be at any frequency, including on a one second basis. The IIV will be disseminated to the public/market, for example, by the exchange or by consolidated ticker.

To provide a level playing field for market participants, the Dynamic SSR Portfolio can be made public to anyone. The fund manager, service provider, exchange, market makers and authorized participants can be provided with full access to the dynamic portfolio allowing them to perform high frequency IIV calculations using their in-house trading systems. Retail investors and registered investment advisors (i.e., RIAs) can access, for example, a read-only real time version available on a dedicated fund website.

While the invention is described primarily using simple price returns, and covariance matrices, it is not limited thereto. For example, logarithmic returns, and correlation matrices, can be utilized, among other possibilities within the scope of the invention.

A stock specific risk (i.e., SSR) is related to the percentage by which the Dynamic SSR Portfolio overlaps with the underlying portfolio. For example, a stock specific risk of 10% means that 95% of the existing exchange traded portfolio is transparent, although shielded.

In certain embodiments of the invention, the actual portfolio weights (of the existing exchange traded portfolio) are input into a computer system (e.g., the custodian's internal computer system) on which the analytical software, and the stock and equal sector weighted covariance matrices, reside. In such a case, the Dynamic SSR Portfolio can be derived relative to the existing exchange traded portfolio.

### Dynamic Weight Construction

Following derivation of the Dynamic SSR Portfolio weights, and prior to the start of the trade day, these weights can be (i) converted into holdings, or (ii) dynamically adjusted throughout the trade day, for example, as exogenous events affect individual stock prices. Thus, the relationships between those stocks contained within the Dynamic SSR Portfolio and actual portfolio (the existing exchange traded portfolio) can be kept at (or close to) an initial target desired stock specific risk level. Although these weights can be converted into actual holdings, the dynamic adjustment of the percentage weights throughout the trade day may be preferred.

### Real Time Operations of the Suite of Modules

Once the Dynamic SSR Portfolio has been generated, it can be disseminated back to the pricing agent, an exchange, market makers, a public website, etc., or others for general distribution and/or publication. Because the disseminated information can be distributed to numerous parties (e.g., an exchange, other market participants, etc.), the frequency of operation can vary significantly (e.g., every 15 seconds for an exchange versus every 1 second for market makers).

Below is an exemplary implementation of the suite of modules, including the key participants, at each stage. In this implementation, the models are hosted by the fund's custodian and/or sub-advisor; however, it is understood that the host can be the fund, the listing exchange, an independent calculation agent, or on a cloud-based system.

After the market closes on a given day, the custodian (or a sub-advisor, or another party, as desired) calculates the stock weighting and sector covariance matrices. This is done to facilitate the determination of the Dynamic SSR Portfolio—all for use during the next trading day. This is accomplished by the automated input of share prices (e.g., from the listing exchange, from the consolidated tape, etc.) and/or the automated input of individual stock and equally weighted sector covariance matrices.

Prior to the next day's market open, the custodian (or a sub-advisor, or another party, as desired) discloses the contents of the Dynamic SSR Portfolio—to promote a level playing field for all market participants. This can be accomplished, for example: (i) by posting on the fund website for wide access, or (ii) by customized disclosure to the fund, APs, market makers, and/or the listing exchange who have the model suite embedded in their systems.

During the next trading day, several parties can use the information provided. For example, the exchange (and/or consolidated tape) can disseminate IIV pricing (e.g., on a predetermined interval, such as every 15 seconds) to provide a pricing signal for retail investors, with a direct feed from the installed pricing model.

Further, the APs can create/redeem, trade, and hedge using the information provided. Thus, liquidity is encouraged, tight bid/asks spreads are provided, and an expected/desired tracking error is maintained. This is accomplished using the customized model suite described herein, in connection with a high frequency IIV calculation.

Further still, the market makers (and traders) can trade, and hedge using the information provided. Again, liquidity is encouraged, tight bid/asks spreads are provided, and an expected/desired tracking error is maintained. This is accomplished using the customized model suite described herein, in connection with a high frequency IIV calculation and/or using disclosures (e.g., online disclosures).

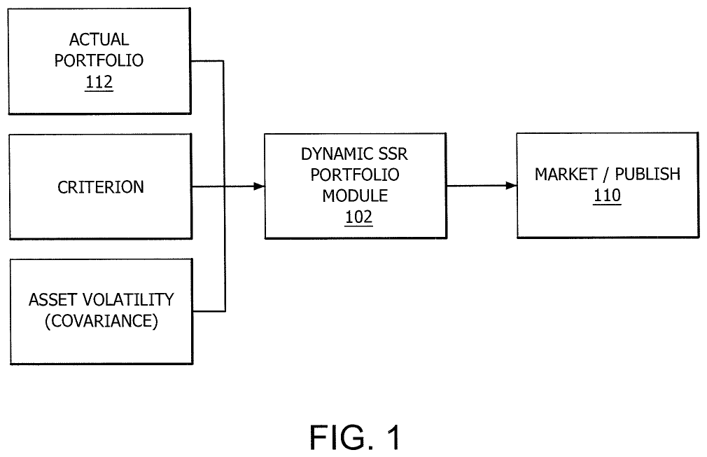

Certain features of the invention are described in relation to the FIGS. 1-3.

FIG. 1 is a block diagram illustrating an exemplary suite of modules (e.g., algorithms), marked as suite 100, such as has been detailed above. An exemplary interaction of the suite of modules 100 is now described. The contents of an Actual Portfolio 112 (e.g., an existing exchange traded fund) are provided to the Dynamic SSR Portfolio Module 102. Module 102 uses the content of Actual Portfolio 112, along with Criterion (e.g., including criteria from an offering document of the existing exchange traded portfolio such as a registration statement and the Fund Manager's criteria for the generated portfolio) and volatility of the portfolio of assets, to generate a portfolio of assets related to actual portfolio 112. The content of the Dynamic SSR Portfolio (including the contents and the weights of the generated portfolio of assets) is provided to the Market 110 such that the content is made public.

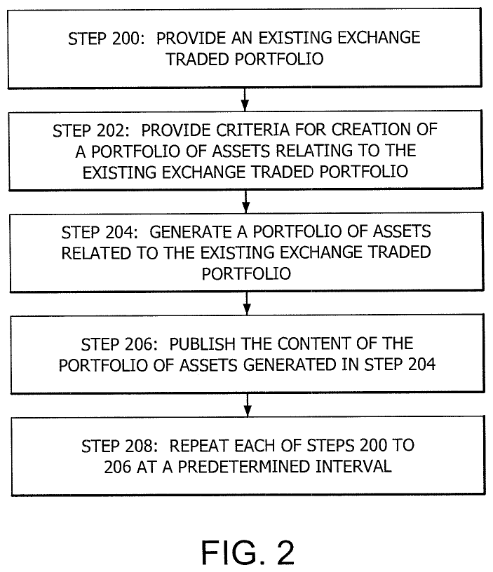

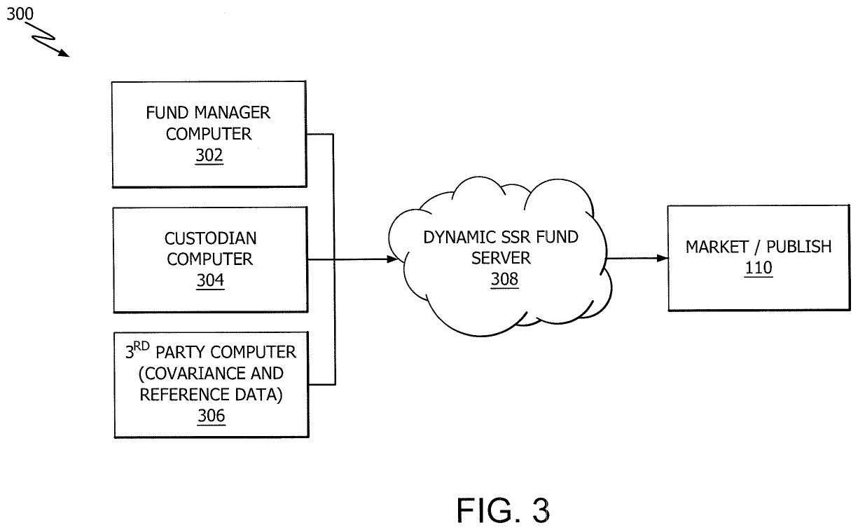

FIGS. 2-3 are flow diagrams illustrating certain exemplary embodiments of the invention. Certain steps included in the flow diagrams can be omitted; certain additional steps can be added; and the order of the steps can be altered from the order illustrated.

FIG. 2 is a flow diagram illustrating a method of assembling a dynamic SSR portfolio in accordance with an exemplary embodiment of the invention. At step 200, an existing exchange traded portfolio (where the assets in the existing portfolio are not public) is provided. At step 202, criteria for the creation of a portfolio of assets related to the existing portfolio provided at step 200, is provided. At step 204, a portfolio of assets related to the existing portfolio provided at step 200 is generated using the existing portfolio and the criteria provided at step 202. At step 206, the content of the portfolio of assets generated at step 204 are published, for example, to the market. At step 208, each of steps 200, 204 and 206 are updated at a predetermined interval.

FIG. 3 is a block diagram of computer network 300, which provides an exemplary network for completing the various inventive methods described herein. It will be appreciated that, while a certain number of computers are shown in the example in FIG. 3, different or additional computers are contemplated. For example, one computer in FIG. 3 can represent multiple computers providing a desired function. Likewise, the function of more than one computer shown in FIG. 3 can be combined into a single computer, and so on.

Computer network 300 includes a fund manager computer 302 which includes an interface, processor, and memory, along with information related to an existing exchange traded portfolio and the Criterion. This information can be provided to the custodian computer 304, which also includes an interface, processor, and memory. Fund manager computer 302 or Custodian computer 304 provides the information related to an existing exchange traded portfolio to the to the Dynamic SSR Fund Server or remote Dynamic SSR Fund Server 308 which includes a server, processor, memory, along with proprietary software 308 (e.g., algorithms) and data structures as described herein, to provide all the various results described herein (e.g., the Dynamic SSR Portfolio). The Dynamic SSR Fund Server or remote Dynamic SSR Fund Server 308 can be hosted locally by a Fund Manager, a Custodian or a designated third-party provider. The Dynamic SSR Fund Server or remote Dynamic SSR Fund Server 308 also receives information (e.g., a covariance matrix and/or other data, as described above) from a third-party computer 306, which itself contains an interface, processor, and memory. Such a third-party computer 306 can be a computer of an exchange or contracted pricing agent that will provide the previous day time series used to calculate individual stock and equal weighted sector covariance matrices for a universe of stocks, as described herein. The various results provided by the Dynamic SSR Fund Server or remote Dynamic SSR Fund Server 308 can be provided to various other computers as shown in FIG. 3, such as the fund computer 302, the Custodian computer 304 or website/publication computer 110, which includes an interface, processor, and memory.

FIG. 4 is a flow diagram illustrating the flow of information of an exemplary embodiment of the invention. It will be appreciated that, while a certain number of computers are shown in the example in FIG. 4, different or additional computers are contemplated. For example, one computer in FIG. 4 can represent multiple computers providing a desired function. Likewise, the function of more than one computer shown in FIG. 4 can be combined into a single computer, and so on.

Computer network 500 includes a fund manager computer 502 which includes an interface, processor, and memory, along with information related to an existing exchange traded portfolio and the Criterion. This information can be provided to the custodian computer 504, which also includes an interface, processor, and memory. Fund manager computer 502 or Custodian computer 504 provides the information related to an existing exchange traded portfolio to the to the Dynamic SSR Fund Server or remote Dynamic SSR Fund Server 508 which includes a server, processor, memory, along with proprietary software (e.g., algorithms) and data structures as described herein, to provide all the various results described herein (e.g., the Dynamic SSR Portfolio). The Dynamic SSR Fund Server or remote Dynamic SSR Fund Server 508 can be hosted locally by a Fund Manager, a Custodian or a designated third-party provider. The Dynamic SSR Fund Server or remote Dynamic SSR Fund Server 508 also receives information (e.g., a covariance matrix and/or other data, as described above) from a third-party computer 510, which itself contains an interface, processor, and memory. Such a third-party computer 510 can be a computer of an exchange or contracted pricing agent that will provide the previous day time series used to calculate individual stock and equal weighted sector covariance matrices for a universe of stocks, as described herein. The various results provided by the Dynamic SSR Fund Server or remote Dynamic SSR Fund Server 508 can be provided to various other computers as shown in FIG. 4, such as the fund computer 502, the Custodian computer 504 or website/publication computer 512, which includes an interface, processor, and memory. Any of these computers can publish the Dynamic SSR to the Exchange Computer 506 or the Market Maker Computer 514 which both which include an interface, processor, and memory.

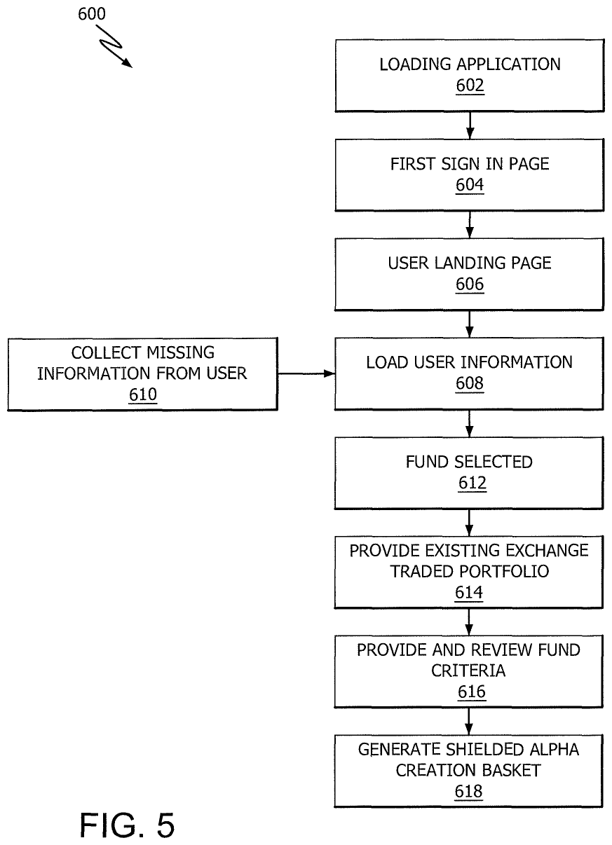

FIG. 5 shows a flow chart of an embodiment of the system. At step 600, a User triggers the loading of the application 602. The application first loads the User Login Page 604 and the User will login using the access details already provided to them. On successful log, the application opens the User Landing Page and Loads the User's Information 608. If information is missing the application will collect the missing information from the User 610. Once all required information has been collected the User can select the required Fund 612 and provide the existing Exchange Traded Portfolio Holding details 614. At step 616, criteria for the creation of a portfolio of assets related to the existing portfolio provided at step 614, is provided. At step 618, a portfolio of assets related to the existing portfolio provided at step 614 is generated using the existing portfolio and the criteria provided at step 616.

Although the invention describes holdings of ETF portfolios primarily in terms of stocks, various types of securities may be included in each portfolio. For example, such securities could include any one or more of commodities, treasuries, notes, options, puts, futures, or alternative currencies, such, as for example, crypto currencies and financial instruments employing block-chain technology.

Certain aspects of the invention are described in the 1940 Act applications filed by the applicant with the SEC. The SEC applications were appended to applicant's U.S. Provisional Patent Application Ser. No. 62/711,928, filed on Jul. 30, 2018, bearing the same title as this application, all of which is incorporated herein by reference in their entireties.

While this subject matter has been disclosed with reference to specific embodiments, other embodiments and variations can be devised by others skilled in the art without departing from the true spirit and scope of the subject matter described herein.

What is claimed:

1. A system for construction and reporting a shielded creation basket for a fund, the system comprising:
a software application operating on a computer device, the software application configured to request and receive through a wired and/or wireless communication network from a fund server in communication with a database, wherein the fund server is located at a fund location or communicates with a remote server through the wired and/or wireless communication network, the shielded creation basket;
a processor in communication through the wired and/or wireless communication network with the software application, as well as the fund server and/or the remote server, the processer is configured to call up for a database of the system upon request:
a list of actual holdings of the fund and corresponding actual weights of each holding, previously uploaded by a fund manager, employee or agent of the fund,
a current number of outstanding fund shares, which has been previously uploaded by the fund manager, employee or agent of the fund,
a list of third parties to whom the shielded creation basket are to be disclosed previously uploaded by the fund manager, employee or agent of the fund; and
at least one guardrail previously uploaded by the fund manager, employee or agent of the fund;
whereby the processor is configured to:
identify at least one shielded weight for each fund holding, which does not violate the at least one guardrail,
compile the shielded creation basket by selecting one shielded weight for each fund holding, and
communicate the shielded creation basket to the software application;
whereby the software application is configured to communicate the shielded creation basket to the third parties.

2. The system of claim 1, wherein at least one guardrail is an acceptable amount of potential deviation in the weightings of the fund holdings in the shielded creation basket for the ETF from the actual weights of each holding.

3. The system of claim 2, wherein the acceptable amount of potential deviation is plus or minus five percent.

4. The system of claim 1 wherein a sum of the shielded weight for each fund holding equals one.

5. The system of claim 1, wherein the system includes two or more guardrails.

6. The system of claim 1 wherein the software application communicates the shielded creation basket to the fund manager, employee or agent of the fund for approval of the shielded creation basket prior to communicating the shielded creation basket to the third parties.

7. The system of claim 1, wherein the shielded creation basket is dynamically determined at predetermined intervals.

8. The system of claim 7, wherein the predetermined interval is in a range from 0.1 seconds to 60 seconds.

9. The system of claim 1, wherein the selection of the one shielded weight for each fund holding is random.

10. A system for construction and reporting a shielded creation basket for a fund, the system comprising:
a website accessible through a wired or wireless communications network by a unique computer device assigned a unique registered fund credential or by a computer device that is synced to a software application operating on the unique mobile computer device, whereby the unique mobile computer device is assigned the unique registered fund credential;
a processor in communication through the wired and/or wireless communication network with the website or software application, as well as the fund server and/or the remote server, the processer is configured to call up for a database of the system upon request:
a list of actual holdings of the fund and corresponding actual weights of each holding, previously uploaded by a fund manager, employee or agent of the fund or linked to the unique registered fund credential, and
at least one guardrail previously uploaded by a fund manager, employee or agent of the fund or linked to the unique registered fund credential;
whereby the processor is configured to:
identify at least one shielded weight for each fund holding, which does not violate the at least one guardrail,
compile the shielded creation basket by selecting one shielded weight for each fund holding, and
communicate the shielded creation basket to the website.

11. The system of claim 10, wherein at least one guardrail is an acceptable amount of potential deviation in the weightings of the fund holdings in the shielded creation basket from the actual weights of each holding.

12. The system of claim 11, wherein the acceptable amount of potential deviation is plus or minus five percent.

13. The system of claim 10 wherein a sum of the shielded weight for each fund holding equals one.

14. The system of claim 10, wherein the system includes two or more guardrails.

15. The system of claim 10 wherein the software application communicates the shielded creation basket to the fund manager, employee or agent of the fund for approval of the shielded creation basket prior to communicating the shielded creation basket to the website.

16. The system of claim 10, wherein the shielded creation basket is dynamically determined at predetermined intervals.

17. The system of claim 16, wherein the predetermined interval is in a range from 0.1 seconds to 60 seconds.

18. The system of claim 10, wherein the selection of the one shielded weight for each shielded creation basket is random.

19. A method for construction and reporting a shielded creation basket for a fund, the method comprising:
receiving a request for a creation basket from a fund server or a remote server placed using a software application operating on a computer device, and wherein the computer device communicates through a wired and/or wireless communication network with the fund server at a fund location or with the remote server in a location that is remote to the fund location and in communication with the fund server;
upon receiving the request for the creation basket, using a processor to randomly call up from a database in communication with the fund server:
a list of actual holdings of the fund and corresponding actual weights of each holding,
a list of third parties to whom the shielded creation basket is to be disclosed, and at least one guardrail;
using the processor to
identify at least one shielded weight for each holding of the shielded creation basket, which does not violate the at least one guardrail, and
compile the shielded creation basket by selecting one shielded weight for each fund holding, and
transmitting shielded creation basket to the software application.

20. The method of claim 19, wherein the selection of the one shielded weight for each fund holding is random.
